(19) United States
(12) Patent Application Publication
(10) Pub. No.: US 2026/0309177 A1
(43) Pub. Date: Oct. 8, 2026

(54) Adjustable Length Rod-End Assembly Having An Integral Secondary Locking Feature

(71) Applicant: Moeller Mfg. Company, LLC, Wixom, MI (US)

(72) Inventors: Eric ZOCHOWSKI, South Lyon, MI (US); Gordon BOGGIE, Jupiter, FL (US)

(73) Assignee: Moeller Mfg. Company, LLC, Wixom, MI (US)

(21) Appl. No.: 19/560,993

(22) Filed: Mar. 9, 2026

Related U.S. Application Data
(60) Provisional application No. 63/784,415, filed on Apr. 7, 2025.

(51) Int. Cl. F16B 7/14; F16B 7/06

(52) U.S. Cl. CPC F16B 7/149; F16B 7/06

(57) ABSTRACT

A precision adjustable length rod-end assembly is disclosed and provides a fastener for mechanical assemblies that eliminates the need for a separate secondary locking device. The rod-end assembly includes a connecting rod, an end connector or rod end, and a lock nut assembly. The rod-end assembly may be adjusted to a precise working length (e.g., as measured along a central longitudinal axis). The lock nut assembly maintains the precision-adjusted working length of the rod-end assembly even when the rod-end assembly is exposed to harsh operating conditions, such as exposure to extreme vibrations.

### CROSS-REFERENCE TO RELATED APPLICATIONS

This application claims the benefit and priority of U.S. Provisional Application No. 63/784,415, filed on Apr. 7, 2025. The entire disclosure of the above application is incorporated herein by reference.

### FIELD

The present disclosure relates to adjustable rod-ends, turnbuckles, and the like for machines, equipment, and mechanical assemblies, particularly of a type requiring secondary locking devices.

### BACKGROUND

This section provides background information related to the present disclosure which is not necessarily prior art.

Machines, equipment, mechanical assemblies, and mechanisms often include a connector or a fastener that provides a connection or joint that maintains a fixed point of contact between two parts as well as rotational freedom. Rod-ends and turnbuckles are types of such connectors that can fasten or support loads (e.g., compression and tension) and/or connect to and control movement of components (e.g., links and pivot points) of associated assemblies and mechanisms. The rod-ends and turnbuckles commonly provide for a variable length that allows the connection to be adjusted to achieve dimensional precision that is needed for a particular mechanical application. In this respect, rod-ends and turnbuckles can incorporate a threaded connection that allows the relative position of components of the fastener (e.g., a connecting rod and a rod-end) to be adjusted so the overall length of the fastener is varied.

Precision rod-ends and turnbuckles are fasteners known to be used in mechanical assemblies and mechanisms that are subject to harsh operating conditions, such as extreme vibration. It is understood that in many applications it is important to ensure that the threaded connection and relative position between the rod-end and the rod do not loosen or change during normal operation or use of the mechanical assembly. This is particularly the case in aircraft applications, where a precision length adjustment of the fastener may be vital to ensure the proper operation of mechanical assemblies or systems used on aircraft.

A known way to maintain the relative positions of the connecting rod and rod-end and lessen a tendency for the connecting rod and/or rod-end to move relative to one another, and thereby impact a precision-adjusted length of the fastener, is by using a locking device, such as a simple lock nut. Further, some applications require a secondary locking device with the fastener. A secondary locking device that may be used in a rod-end is a lock nut assembly including a locking ring that captures a thrust nut to prevent possible loosening of the rod-end. See Prior Art FIG. 1.

Other locking mechanisms may include the use of a lock wire, also known as safety wire. Lock wire is often used in situations where mechanical reliability is critical. For example, in aircraft applications, safety wire is used to secure the lock nuts on rod-ends and turnbuckles, as well as with other fasteners in the aircraft. This is because the significant vibration and other forces that act on the aircraft and its components and mechanisms can contribute to the fasteners inadvertently becoming loose.

In order to service mechanical components and mechanisms, or other systems that include lock-wired fasteners, however, such as for inspection, maintenance, repair, replacement, and the like, the lock wire needs to be cut off and disconnected from the fastener before the fastener can be loosened and removed. After the inspection or other work is performed, the fasteners can be reused but they must be re-lock-wired. This process requires specialized skills and training, is labor intensive, and time consuming. Thus, the costs to perform routine maintenance, inspection or other service activities are increased.

Furthermore, in some applications, the maintenance, inspection, repair, replacement, or other service activity needed is performed on apparatuses that may be located where there is limited space to easily employ or manipulate the tools necessary to remove the lock wire, unfasten the fasteners, and/or re-lock-wire the fasteners after service. These conditions add further difficulties, labor, and cost to otherwise routine tasks.

### SUMMARY

This section provides a general summary of the disclosure and is not a comprehensive disclosure of its full scope or all of its features.

In a first aspect, the disclosure provides an adjustable length rod-end assembly comprising an end connector extending along a central longitudinal axis and a male-threaded shaft, a connecting rod extending along the central longitudinal axis, the connecting rod including a female-threaded shaft having a head defining a face and a first engagement feature, wherein the male-threaded shaft of the end connector threadedly engages the female-threaded shaft of the connecting rod to define a precise overall length of the adjustable length rod-end assembly along the central longitudinal axis; and a lock nut assembly engaging both the end connector and the connecting rod and configured to fix the precise overall length of the adjustable length rod-end assembly along the central longitudinal axis, the lock nut assembly comprising a primary locking feature and a secondary locking feature and including a thrust nut and a locking ring, the thrust nut being fixedly connected to the connecting rod and the locking ring being rotatably fixed relative to the connecting rod, wherein the thrust nut comprises a body having an internal wall and a detent interface, the thrust nut being rotationally fixed relative to the connecting rod through the first engagement feature and the end connector by a second engagement feature, the first engagement feature and the second engagement feature forming the primary locking feature of the adjustable length rod-end assembly, wherein the detent interface comprises an outer cylindrical wall in which are included a plurality of concave-shaped detents that are equally spaced about a circumference of the outer cylindrical wall, wherein adjacent detents are separated from one another by discrete sections of the outer cylindrical wall; wherein the locking ring comprises a locking ring body including a ring-like portion having a central opening and a plurality of resilient beam fingers; wherein the plurality of resilient beam fingers are arranged and equally spaced about a circumference of the body, wherein each of the plurality of resilient beam fingers extends in a first direction from the body in a cantilevered manner from a proximal end to a distal end, wherein each of the plurality of resilient beam fingers extends generally parallel to the central longitudinal axis; and wherein the distal ends of each of the plurality of resilient beam fingers mechanically interacts with the detent interface to inhibit rotation of the thrust nut to provide the secondary locking feature of the adjustable length rod-end assembly.

In another aspect, the disclosure provides an adjustable length rod-end assembly comprising an end connector extending along a central longitudinal axis and a male-threaded shaft; a connecting rod extending along the central longitudinal axis, the connecting rod including a female-threaded shaft having a head defining a face, wherein the male-threaded shaft of the end connector threadedly engages the female-threaded shaft of the connecting rod to define a precise overall length of the adjustable length rod-end assembly along the central longitudinal axis; and a lock nut assembly engaging both the end connector and the connecting rod and configured to fix the precise overall length of the adjustable length rod-end assembly along the central longitudinal axis, the lock nut assembly comprising a primary locking feature and a secondary locking feature and including a thrust nut and a locking ring, the locking ring being rotatably fixed relative to the end connector, wherein the thrust nut comprises a body having an internal wall supporting a female-threaded surface and a detent interface, the female-threaded shaft being threadedly connected with the male-threaded shaft of the end connector, wherein the detent interface comprises an outer cylindrical wall in which are included a plurality of concave-shaped detents that are equally spaced about a circumference of the outer cylindrical wall, wherein adjacent detents are separated from one another by discrete sections of the outer cylindrical wall; wherein the locking ring comprises a locking ring body including a ring-like portion having a central opening and a plurality of resilient beam fingers, the ring-like portion including a first engagement feature that rotationally fixes the locking ring body relative to the connecting rod and a second engagement feature that rotationally fixes the locking ring body to the end connector, the first engagement feature and the second engagement feature forming the primary locking feature of the adjustable length rod-end assembly; wherein the plurality of resilient beam fingers are arranged and equally spaced about a circumference of the body, wherein each of the plurality of resilient beam fingers extends in a first direction from the body in a cantilevered manner from a proximal end to a distal end, wherein each of the plurality of resilient beam fingers extends generally parallel to the central longitudinal axis; and wherein the distal ends of each of the plurality of resilient beam fingers mechanically interacts with the detent interface to inhibit rotation of the thrust nut to provide the secondary locking feature of the adjustable length rod-end assembly.

In still another aspect, the disclosure provides an adjustable length rod-end assembly comprising: an end connector extending along a central longitudinal axis and a male-threaded shaft; a connecting rod extending along the central longitudinal axis, the connecting rod including a female-threaded shaft having a head, wherein the male-threaded shaft of the end connector threadedly engages the female-threaded shaft of the connecting rod to define a precise overall length of the adjustable length rod-end assembly along the central longitudinal axis; and a lock nut assembly engaging both the end connector and the connecting rod and configured to fix the precise overall length of the adjustable length rod-end assembly along the central longitudinal axis, the lock nut assembly comprising a primary locking feature and a secondary locking feature and including a thrust nut and a locking ring, the locking ring being rotatably fixed relative to the connecting rod and the thrust nut being rotatably fixed relative to the end connector, wherein the thrust nut comprises a body having a central opening including an internal wall and a detent interface, wherein the detent interface comprises an outer cylindrical wall in which are included a plurality of concave-shaped detents that are equally spaced about a circumference of the outer cylindrical wall, wherein adjacent detents are separated from one another by discrete sections of the outer cylindrical wall; wherein the locking ring comprises a locking ring body including a ring-like portion having a central opening and a plurality of resilient beam fingers, the ring-like portion including a first engagement feature that rotationally fixes the locking ring body relative to the connecting rod, the body of the thrust nut including a second engagement feature that rotatably fixes the thrust nut relative to the end connector, the first engagement feature and the second engagement feature forming the primary locking feature of the adjustable length rod-end assembly; wherein the plurality of resilient beam fingers are arranged and equally spaced about a circumference of the body, wherein each of the plurality of resilient beam fingers extends in a first direction from the body in a cantilevered manner from a proximal end to a distal end, wherein each of the plurality of resilient beam fingers extends generally parallel to the central longitudinal axis; wherein the distal ends of each of the plurality of resilient beam fingers mechanically interacts with the detent interface to inhibit rotation of the thrust nut and provide the secondary locking feature of the adjustable length rod-end assembly; and wherein the central opening of the thrust nut includes a first tab projecting radially outwardly from the internal wall and a second tab projecting radially outwardly from the internal wall, the first tab and the second tab being configured to engage with a first longitudinal slot and a second longitudinal slot formed on the male-threaded shaft to form the second engagement feature.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 shows a conventional rod-end of the prior art;

FIG. 2 is a top-front-right isometric view of an adjustable, self-locking rod-end, in accordance with an aspect of the present disclosure;

FIG. 3 is a disassembled, top-front-right isometric view of the adjustable, self-locking rod-end of FIG. 2;

FIG. 4 is an enlarged, cross-sectional detail view along the line 4-4 of FIG. 2;

FIG. 5A is a top-front-right isometric view of a thrust nut of the adjustable, self-locking rod-end of FIG. 2;

FIG. 5B is a top-left-front isometric view of the thrust nut of FIG. 5A;

FIG. 6A is a top-front-right isometric view of a locking ring of the adjustable, self-locking rod-end of FIG. 2;

FIG. 6B is a top-left-front isometric view of the locking ring of FIG. 6A.

FIG. 7 is a top-front-right isometric view of an adjustable, self-locking rod-end, in accordance with another aspect of the present disclosure;

FIG. 8 is a disassembled, top-front-right isometric view of the adjustable, self-locking rod-end of FIG. 7;

FIG. 9 is an enlarged, cross-sectional detail view along the line 9-9 in FIG. 7;

FIG. 10A is a top-front-right isometric view of a thrust nut of the adjustable, self-locking rod-end of FIG. 7;

FIG. 10B is a top-left-front isometric view of the thrust nut of FIG. 10A;

FIG. 11A is a top-front-right isometric view of a locking ring of the adjustable, self-locking rod-end of FIG. 7;

FIG. 11B is a top-left-front isometric view of the locking ring of FIG. 11A;

FIG. 12 is a top-front-right isometric view of an adjustable, self-locking rod-end, in accordance with yet another aspect of the present disclosure;

FIG. 13 is a disassembled, top-front-right isometric view of the adjustable, self-locking rod-end of FIG. 12;

FIG. 14 is an enlarged, cross-sectional detail view along the line 14-14 in FIG. 12;

FIG. 15A is a top-front-right isometric view of a thrust nut of the adjustable, self-locking rod-end of FIG. 12;

FIG. 15B is a top-left-front isometric view of the thrust nut of FIG. 15A;

FIG. 16A is a top-front-right isometric view of a lock ring of the adjustable, self-locking rod-end of FIG. 12; and

FIG. 16B is a top-left-front isometric view of the lock ring of FIG. 16A.

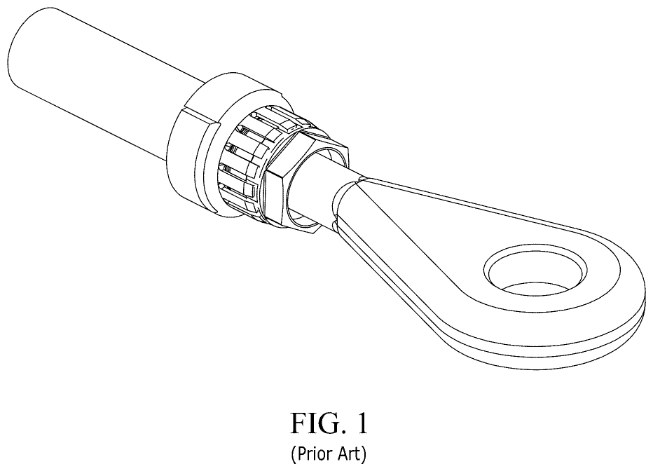

Corresponding reference numerals indicate corresponding parts throughout the several views of the drawings.

### DETAILED DESCRIPTION

Example embodiments will now be described more fully with reference to the accompanying drawings.

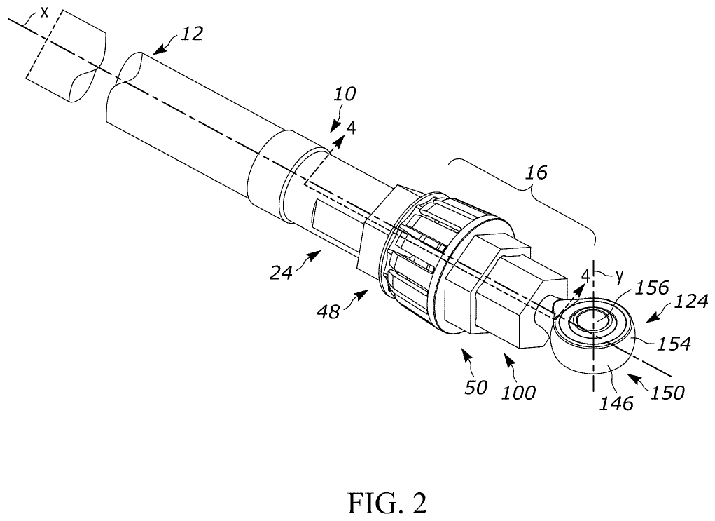

The adjustable, self-locking rod-end assembly 10, in accordance with an aspect of the present disclosure (e.g., FIGS. 2-6B) provides a fastener or connector for use in machines, equipment, mechanical assemblies and like apparatus that enables precision adjustability and includes a self-locking feature that eliminates the need for a secondary locking device like lock wire. The adjustable, self-locking rod-end assembly 10 extends lengthwise along a central longitudinal axis X.

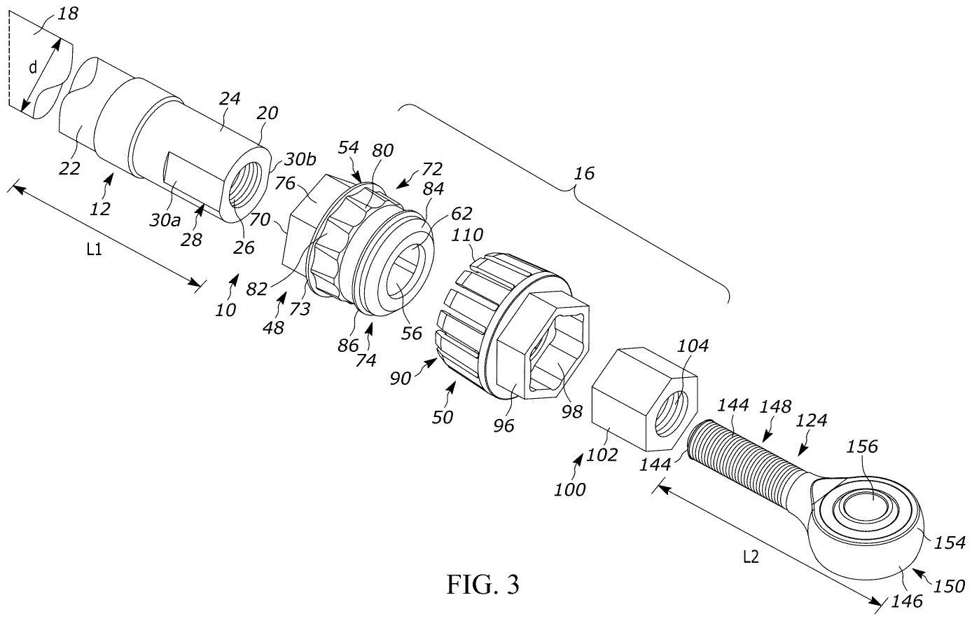

Referring to FIGS. 2 and 3, the adjustable, self-locking rod-end assembly 10 of the present disclosure generally includes a connecting rod 12, an end connector or rod-end 124, and a lock nut assembly 16. The rod-end 124 adjustably engages the connecting rod 12 and lock nut assembly 16. The lock nut assembly 16 engages both the rod-end 124 and the connecting rod 12. The self-locking rod-end assembly 10 extends for a working length along the central longitudinal axis X. The threaded engagement between the rod-end 124, the connecting rod 12 and the lock nut assembly 16 enables the self-locking rod-end assembly 10 to be adjusted to a precise working length (e.g., as measured along the central longitudinal axis X). In addition to facilitating adjustment of the rod-end 124, the lock nut assembly 16 maintains the precision-adjusted working length of the self-locking rod-end assembly 10 even when the self-locking rod-end assembly 10 is exposed to harsh operating conditions, such as exposure to extreme vibrations.

The connecting rod 12 can be generally understood as similarly configured as any of a number of well-known internally or externally threaded connecting rods, turnbuckle connecting rods, or hollow, female-threaded rods. For example, as shown in FIGS. 2 and 3, the connecting rod 12 can extend along the central longitudinal axis X for a length L1 from a first or proximal end 18 to a second or distal end 20. The length L1 of the connecting rod 12 can vary. The connecting rod 12 can include a shaft 22 and an engagement portion or head 24. The outer shape or configuration of the shaft 22 can be generally cylindrical or polygonal or another suitable shape. The shape of the connecting rod 12 can be symmetrical or asymmetrical about the longitudinal axis X. The shaft 22 can have an outer dimension (e.g., a diameter d or height and width, as applicable). Further, it is contemplated that the head 24 can include an outer dimension substantially similar to the shaft's 22 (e.g., about a diameter d or height and width, as applicable).

The shaft 22 can be partially or completely hollow and define an inner surface or internal wall 26 at least at the distal end 20. A portion or the entirety of the internal wall 26 can be threaded (e.g., can include female threads). The threads can have a fine or coarse thread pitch. As can be appreciated, the finer the thread pitch, the greater the precision with which the working length of the self-locking rod-end assembly 10 can be adjusted.

The engagement portion or head 24 of the connecting rod 12 can be incorporated at the distal end 20 of the shaft 22. The head 24 can be integrally formed with the shaft 22 or otherwise be affixed or secured to the distal end 20 of the shaft 22. The outer shape or configuration of the head 24 can be similarly formed to the shaft 22. The outer shape of the head 24 can include a first engagement feature 28 that connects with lock nut assembly 16 as will be detailed herein. First engagement feature 28 may include one or more flats such as shown at 30a and 30b. The flats 30a and 30b can be opposed to and parallel to one another. The flats 30 and 30b can include depressions separated by the outer shape of the head 24.

The end connector or rod-end 124 can be generally understood as similarly configured as any of a number of well-known internally-or externally-threaded rod-ends. For example, the end connector or rod-end 124 is shown in FIGS. 2 and 3. The rod-end 124 can extend along the central longitudinal axis X for a length L2 from a first or proximal end 144 to a second or distal end 146. The length L2 of the end connector 124 can vary. The rod-end 124 can include a shaft 148 and connecting portion 150. The shaft 148 can be partially or completely threaded (e.g., to include male threads). The male threads can have a fine or coarse thread pitch. The male threads can correspond to and mate with the female threads of the connecting rod 12. The connecting portion 150 can be integrally formed with the shaft 148 of the rod-end 124. The connecting portion 150 can comprise a rod-end bolt, a ball joint rod-end, a ball joint linkage, a clevis rod-end, a swivel shaft rod-end, or other known connection feature. As shown in FIGS. 2 and 3, the connecting portion 150 is a rod-end bolt 154 having a cylindrical mounting hole 156 extending through the rod-end bolt 154 along a centerline Y and near to the distal end 146 of the rod-end 124.

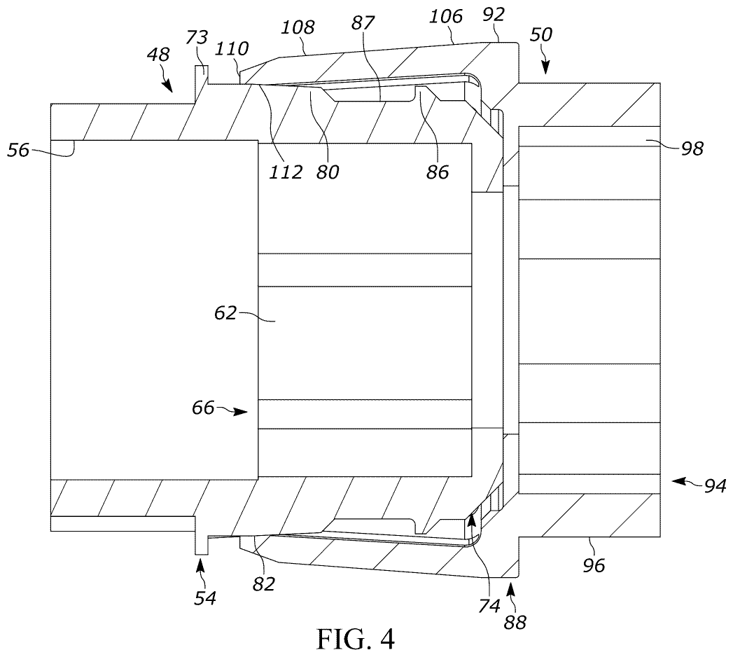

With reference to FIGS. 4, 5A, 5B, 6A, 6B, and with continued reference to FIGS. 2 and 3, lock nut assembly 16 will now be described. The lock nut assembly 16 can have a locked condition and an unlocked condition. The lock nut assembly 16 can include a thrust nut 48 and a locking ring 50. The locking ring 50 can be disposed between the thrust nut 48 and rod-end 124. The locking ring 50 can be rotationally fixed relative to the rod-end 124, as further described herein. The thrust nut 48 and locking ring 50 may be brought together along the central longitudinal axis X to place the lock nut assembly 16 in the locked condition. In the locked condition of the lock nut assembly 16, the locking ring 50 can capture the thrust nut 48 and prevent an unintended loosening rotation of the rod-end 124.

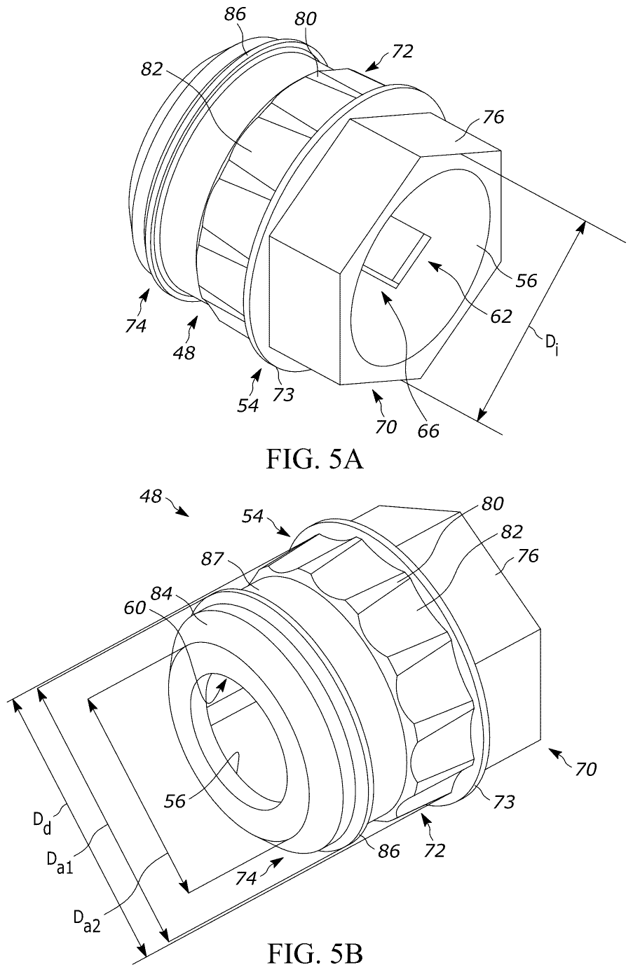

The thrust nut 48 of the lock nut assembly 16 is best seen in FIGS. 5A and 5B. For example, the thrust nut 48 can have a hollow, generally cylindrically-shaped body 54 extending along the central longitudinal axis X. The hollow interior of the body 54 of thrust nut 48 can define an inner surface or internal surface 56 extending through the body 54 of thrust nut 48. Internal surface 56 can be generally circular and corresponds with head 24 of shaft 22. Internal surface 56 may include a first raised feature 60 and a second raised feature 62. First raised feature 60 and second raised feature 62 accommodate flats 30a and 30b and serve as anti-rotation mechanism 66 that prevents relative rotation of thrust nut 48 and shaft 22.

The outer side of the body 54 can be described as defining a head 70, a detent interface 72, and a leading end or abutment portion 74. The head 70 of the outer side of the body 54 is configured to accommodate a tool for applying a torque to the thrust nut 48 and for holding the thrust nut 48 against a rotational force. For example, the head 70 can include one or more tool-engaging surfaces 76 or “flats.” In particular, as shown in FIG. 5A, the head 70 can be polygonal-shaped (e.g., hexagonal) and have a plurality (e.g., 6) of exterior surfaces that a wrench or similar tool can engage to act on the thrust nut 48.

Referring again to FIGS. 5A and 5B, the detent interface 72 can be formed or located on the outer side of the body 54 between the head 70 and the abutment portion 74. An annular flange 73 may separate head 70 and detent interface 72. The annular flange 73 projects proudly of the head 70 and the detent interface 72. Referring more specifically to the detent interface 72, a portion of the outer side of the body 54 can define a generally cylindrical outer circumferential wall 80 having a diameter (Dᵢ).

Included about the circumference of the generally cylindrical outer circumferential wall 80 are a plurality of equally-spaced, concave-shaped depressions or detents 82. Adjacent detents 82 can be separated from one another by discrete sections of the outer circumferential wall 80. It can be appreciated that the number of detents 82 can vary. For example, about 12 to 20 detents 82 can be included about the outer circumferential wall 80.

Further, it is contemplated that the detent interface 72 can be integrally formed with the outer side of the body 54 of the thrust nut 48. Alternatively, the detent interface 72 can be provided by way of a separate component (e.g., a detent ring) that can be assembled with and/or secured to the outer side of the body 54 of the thrust nut 48. In this respect, the separate detent ring, if so provided, can include the outer circumferential and cylindrical wall 80 comprising the plurality of detents 82. Additionally, the separate detent ring, if so provided, can have an inner side that can be attached to the outer side of the body of the thrust nut. The detent ring can be secured to the thrust nut 48, e.g., by a press fit, screw threads, welding, or otherwise.

The abutment portion 74 of the thrust nut 48 can provide a tapered leading end to the thrust nut 48. The abutment portion 74 can have a tapered end 84, an annular flange 86, and a lead-in surface 87. The annular flange 86 can promote retention of locking ring 50. The annular flange 86 defines a first outer diameter (Dₐ₁) and lead-in surface 87 defines a second outer diameter (Dₐ₂) that is less than the first outer diameter. The lead-in surface 87 provides a smooth transition to detents 82 that promotes engagement with the locking ring 50. When the lock nut assembly 16 is in the locked condition, the abutment portion 74 of the thrust nut 48 can be nested within the locking ring 50.

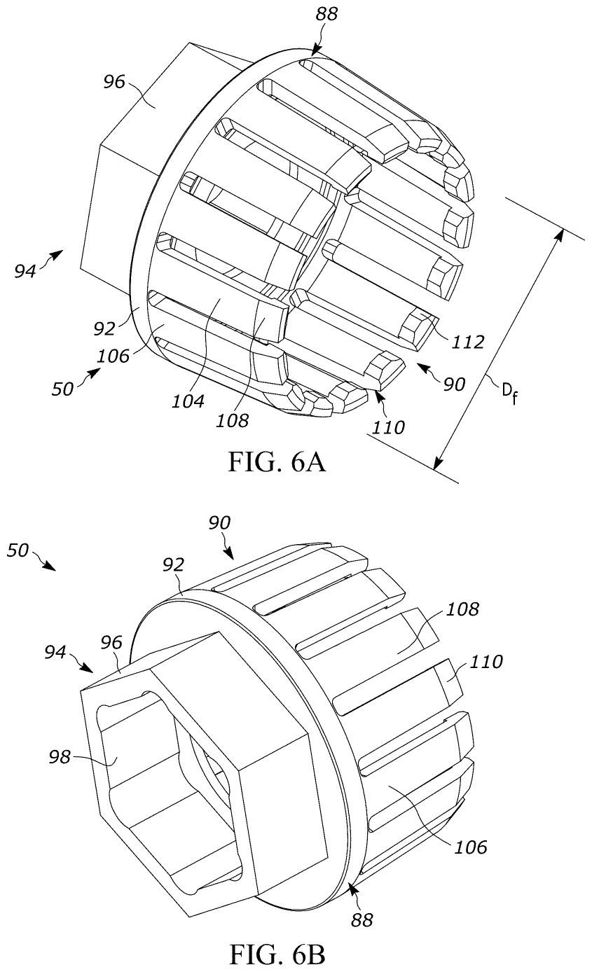

Reference will now be made to FIGS. 6A and 6B, in describing locking ring 50 in accordance with the present disclosure. Locking ring 50 includes a locking ring body 88 and a plurality of flexible and resilient beam fingers 90. The beam fingers 90 can extend from the locking ring body 88 in a first direction. The locking ring body 88 can have a generally ring-like portion 92. The beam fingers 90 can be arranged about a circumference of the ring-like portion 92 of the locking ring body 88. It can be appreciated that the number of beam fingers 90 can vary. For example, about 12 to 20 beam fingers can be included. The number of beam fingers 90 on locking ring 50 may correspond to the number of detents 82 on thrust nut 48.

The locking ring body 88 can also include a second engagement feature 94. The second engagement feature 94 of the locking ring body 88 of the locking ring 50 can include an outer surface configured to accommodate a tool for resisting a torque that may be applied to locking ring 50. For example, second engagement feature 94 can include one or more tool-engaging surfaces 96 or “flats.” In particular, as shown in FIG. 6B, second engagement feature 94 can be polygonal-shaped (e.g., hexagonal) and have a plurality (e.g., 6) of exterior surfaces that a wrench or similar tool can engage to act on the locking ring 50. Second engagement feature 94 may also include a hollow interior 98 that is also hexagonal in shape. Hollow interior 98 may be receptive to a mechanical fastener 100 (FIG. 3) that is secured to shaft 38 of rod-end 124. Mechanical fastener 100 is shown in the form of a hex-nut 102 including a central, threaded opening 104. Hollow interior 98 includes a hexagonal geometry that is substantially the same as the geometry of hex-nut 102. With this configuration, mechanical fastener 100, when received within hollow interior 98, is rotationally fixed relative to locking ring 50.

With continued reference to FIGS. 6A and 6B, each beam finger 90 of the locking ring 50 extends or projects in the first direction from the ring-like portion 92 of the locking ring body 88 from a proximal end 106 to a distal end 108. The beam fingers 90 extend in a cantilevered manner. The beam fingers 90 are substantially parallel to the central longitudinal axis X. The distal ends 108 of the beam fingers 90 define fingertips 110. The fingertips 110 of the beam fingers 90 each include a plurality of beveled surfaces 112. In an aspect of the disclosure, the beveled surfaces 112 are located on the inner sides (i.e., inwardly facing toward the central longitudinal axis) of the fingertips 110. The inner sides of the fingertips 110 form a beam finger opening (not separately labeled) having a finger diameter (D_{f}) that is substantially similar to the second outer diameter (Dₐ₂) of thrust nut 48.

The beam fingers 90 are resilient and, due to the cantilevered arrangement, the beam fingers 90 can exhibit limited spring-like flexibility or elastic deformation in a direction generally transverse to the central longitudinal axis X (i.e., diametrically inward and outward) when subjected to a force, particularly a normal force at the fingertips 110. As further described herein, the fingertips 110 of the beam fingers 90 are configured to mechanically interact with a detent interface 72 of the thrust nut 48. That is, the taper of abutment portion 74 of thrust nut 48 serves as a lead-in surface that spreads beam fingers 90 so as to receive detents 82 to establish a locked condition (i.e., the lock nut assembly 16 is engaged). In the locked condition, the beam fingers 90 and detent interface 72 co-operate with the locking ring 50 to inhibit unintended rotation of the thrust nut 48 relative to the locking ring 50.

As shown in FIG. 4, when the rod-end 124 is threaded to the connecting rod 12 to achieve the precise working length (L) of the self-locking rod-end assembly 10, the locking ring 50 is engaged with the rod-end 124 and the thrust nut 48 is engaged with head 24 of connecting rod 12. In the locked condition, the locking ring 50 is rotated in a tightening manner causing mechanical fastener 100 to move along the shaft 22 of rod-end 124 toward the connecting rod 12. As locking ring 50 is rotated, rod-end 14 threads into shaft 22. Continued rotation of locking ring 50 causes the beam fingers 90 of the locking ring 50 to engage the detent interface 72 of the thrust nut 48.

As previously described, the cantilevered beam fingers 90 are resiliently flexible, thus as the locking ring 50 is rotated, the fingertips 110 of the beam fingers 90 can alternatively engage the detents 82 (as seen in FIG. 4) and the outer circumferential wall 80 of the detent interface 72 in a “snap-acting” manner. That is, when the fingertips 110 engage the outer circumferential wall 80 of the detent interface 72, the resilient beam fingers 90 are biased outwardly, normal from the central longitudinal axis X. As such, the beam fingers 90 apply a normal force against the detent interface 72 of the thrust nut 48 and produce a tangential friction force against the thrust nut 48. The beveled surfaces 118 of the fingertips 110 aid in the smooth engagement between the beam fingers 90 and detent interface 72. When continued rotation of locking ring 50 causes the beam fingers 90 to engage the detents 82, the bias against the beam fingers 90 is removed and the beam fingers 90 “snap” into engagement with the detents 82. Consequently, the locking ring 50 produces a resistance to rotation that must be overcome during both tightening and loosening of the mechanical fastener 100. As can be appreciated, rotation of locking ring 50 can be easily accomplished with a tool, and loosening without a tool is substantially prevented.

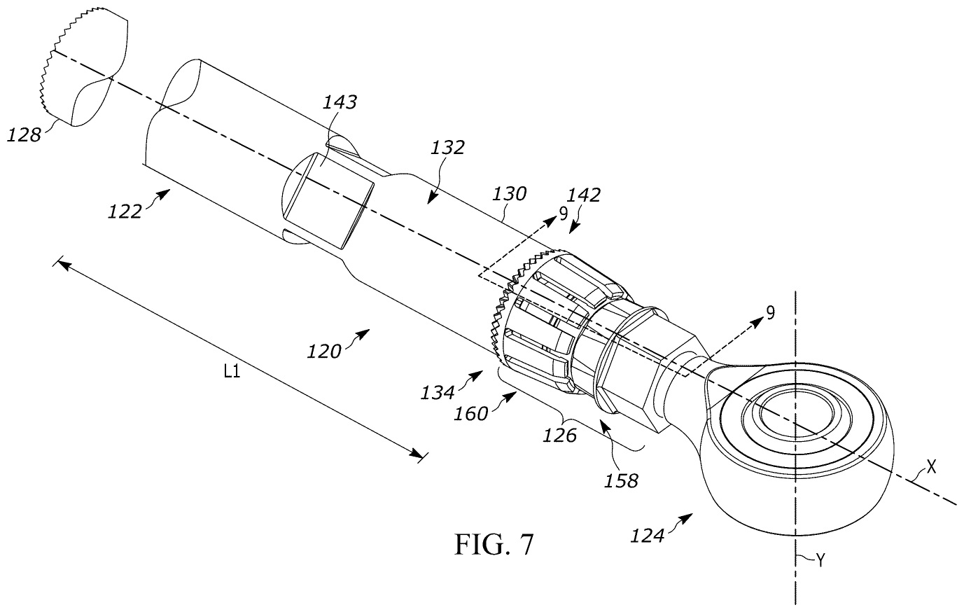

Reference will now follow to FIGS. 7, 8, and 9 in describing an adjustable, self-locking rod-end assembly 120 in accordance with another aspect of the present disclosure. In a manner similar to that discussed herein, the adjustable, self-locking rod-end assembly 120 of the present disclosure (e.g., FIGS. 7-9) provides a fastener or connector for use in machines, equipment, mechanical assemblies and like apparatus that enables precision adjustability and includes a self-locking feature that eliminates the need for a secondary locking device like lock wire. The adjustable, self-locking rod-end assembly 120 extends lengthwise along a central longitudinal axis X.

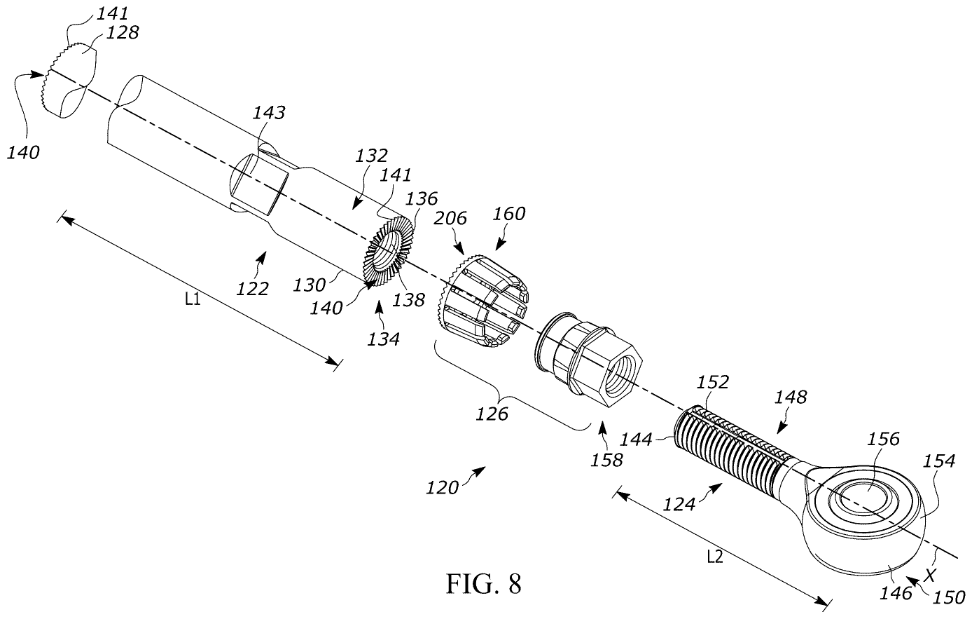

Referring to FIGS. 7 and 8, the adjustable, self-locking rod-end assembly 120 of the present disclosure generally includes a connecting rod 122, an end connector or rod-end 124, and a lock nut assembly 126. The end connector 124 adjustably engages the connecting rod 122 and lock nut assembly 126. The lock nut assembly 126 engages both the end connector 124 and the connecting rod 122. The self-locking rod-end assembly 120 extends for a working length along the central longitudinal axis X. The threaded engagement between the end connector 124, the lock nut assembly 126, and connecting rod 122 enables the self-locking rod-end assembly 120 to be adjusted to a precise working length (e.g., as measured along the central longitudinal axis X). In addition to facilitating adjustment of the rod-end 124, the lock nut assembly 126 maintains the precision-adjusted working length of the self-locking rod-end assembly 120 even when the self-locking rod-end assembly 120 is exposed to harsh operating conditions, such as exposure to extreme vibrations.

The connecting rod 122 can be generally understood as similarly configured as any of a number of well-known internally or externally threaded connecting rods, turnbuckle connecting rods, or hollow, female-threaded rods. For example, as shown in FIGS. 7 and 8, the connecting rod 122 can extend along the central longitudinal axis X for a length L1 from a first or proximal end 128 to a second or distal end 130. The length L1 of the connecting rod can vary. The connecting rod 122 can include a shaft 132 having an engagement portion or head 134 having a face 136. The outer shape or configuration of the shaft 132 can be generally cylindrical or polygonal or another suitable shape. The shape of the shaft 132 can be symmetrical or asymmetrical about the longitudinal axis X. The shaft 132 can have an outer dimension (e.g., a diameter d or height and width, as applicable).

The shaft 132 can be partially or completely hollow and define an inner surface or internal wall 138 at least at the distal end 130. A portion or the entirety of the internal wall 138 can be threaded (e.g., can include female threads). The threads can have a fine or coarse thread pitch. As can be appreciated, the finer the thread pitch, the greater the precision with which the working length of the self-locking rod-end assembly 120 can be adjusted.

The engagement portion or head 134 of the connecting rod 122 can be incorporated at the distal end 130 of the shaft 132. The head 134 can be integrally formed with the shaft 132 or otherwise be affixed or secured to the distal end 130 of the shaft 132. The outer shape or configuration of the head 134 can be similarly formed to the shaft 132. Face 136 of the head 134 can include a first sawtooth or serrated surface 140 including a plurality of first teeth elements 141, which forms part of a first engagement feature 142 that rotationally connects shaft 132 to lock nut assembly 126, as will be detailed herein. Shaft 132 may also include a tool engagement portion formed by a plurality of flats 143.

The end connector or rod-end 124 can be generally understood as similarly configured as any of a number of well-known internally-or externally-threaded rod-ends. For example, an end connector or rod-end 124 is also shown in FIGS. 7 and 8. The end connector 124 can extend along the central longitudinal axis X for a length L2 from a first or proximal end 144 to a second or distal end 146. The length L2 of the end connector can vary. The end connector 124 can include a shaft 148 and a connecting portion 150. The shaft 148 can be partially or completely threaded (e.g., to include male threads) and includes a longitudinal keyway or longitudinal slot 152. The male threads can have a fine or coarse thread pitch. The male threads can correspond to and mate with the female threads of the connecting rod 122. The connecting portion 150 can be integrally formed with the shaft 148 of the end connector 124. The connecting portion 150 can comprise a rod-end bolt, a ball joint rod-end, a ball joint linkage, a clevis rod-end, a swivel shaft rod-end, or other known connection feature. As shown in FIGS. 7 and 8, the connecting portion 150 is a rod-end bolt 154 having a cylindrical mounting hole 156 extending through the rod-end bolt 154 along a centerline Y and near to the distal end 146 of the end connector rod-end 124.

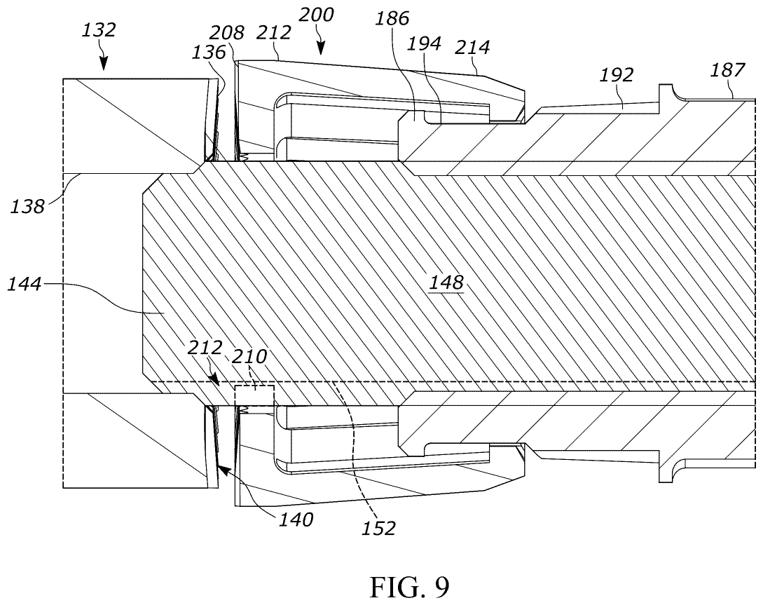

With reference to FIGS. 9, 10A, 10B, 11A, 11B, and with continued reference to FIGS. 7 and 8, lock nut assembly 126 will now be described. The lock nut assembly 126 can have a locked condition and an unlocked condition. The lock nut assembly 126 can include a thrust nut 158 and a locking ring 160. The thrust nut 158 can be disposed between the locking ring 160 and rod-end 124. The locking ring 160 can be rotationally fixed relative to the rod-end 124, as further described herein. The thrust nut 158 and locking ring 160 may be brought together along the central longitudinal axis X to place the lock nut assembly 126 in the locked condition. In the locked condition of the lock nut assembly 126, the locking ring 160 can capture the thrust nut 158 and prevent an unintended loosening rotation of the rod-end 124.

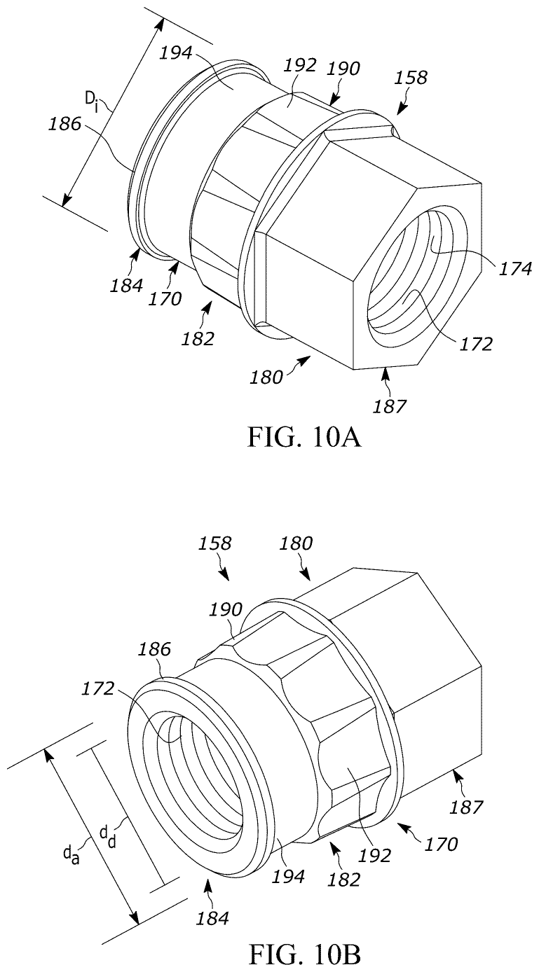

The thrust nut 158 of the lock nut assembly 126 is best seen in FIGS. 10A and 10B. For example, the thrust nut 158 can have a hollow, generally cylindrically-shaped thrust nut body 170 extending along the central longitudinal axis X. The hollow interior of the thrust nut body 170 can define an inner surface or internal surface 172. Internal surface 172 may include a plurality of threads 174 that extend through the thrust nut body 170 to provide a mechanical connection between rod-end 124 and lock nut assembly 126. Thus, internal surface 172 can be generally circular and corresponds with shaft 148 of rod-end 124.

The outer side of the thrust nut body 170 can be described as defining a head 180, a detent interface 182, and a leading end or abutment portion 184. The head 180 of the outer side of the thrust nut body 170 is configured to accommodate a tool for applying a torque to the thrust nut 158 and for holding the thrust nut 158 against a rotational force. For example, the head 180 can include one or more tool-engaging surfaces 187 or “flats.” In particular, as shown in FIG. 10A, the head 180 can be polygonal-shaped (e.g., hexagonal) and have a plurality (e.g., 6) of exterior surfaces that a wrench or similar tool can engage to act on the thrust nut 158.

Referring again to FIGS. 10A and 10B, the detent interface 182 can be formed or located on the outer side of the thrust nut body 170 between the head 180 and the abutment portion 184. Referring more specifically to the detent interface 182, a portion of the outer side of the thrust nut body 170 can define a generally cylindrical outer circumferential wall 190 having a diameter (Dᵢ).

Included about the circumference of the generally cylindrical outer circumferential wall 190 are a plurality of equally-spaced, concave-shaped depressions or detents 192. The depths of detents 192 define a diameter (D_{d}). Adjacent detents 192 can be separated from one another by discrete sections of the outer circumferential wall 190. It can be appreciated that the number of detents 192 can vary. For example, about 12 to 20 detents 192 can be included about the outer circumferential wall 190.

Further, it is contemplated that the detent interface 182 can be integrally formed with the outer side of the thrust nut body 170 of the thrust nut 158. Alternatively, the detent interface 182 can be provided by way of a separate component (e.g., a detent ring) that can be assembled with and/or secured to the outer side of the thrust nut body 170 of the thrust nut 158. In this respect, the separate detent ring, if so provided, can include the outer circumferential and cylindrical wall 190 comprising the plurality of detents 192. Additionally, the separate detent ring, if so provided, can have an inner side that can be attached to the outer side of the body of the thrust nut. The detent ring can be secured to the thrust nut 158, e.g., by a press fit, screw threads, welding, or otherwise.

The abutment portion 184 of the thrust nut 158 can provide a leading end to the thrust nut 158. The abutment portion 184 can have an outer annular flange 186 that promotes retention of locking ring 160. The outer annular flange 186 defines an outer diameter (dₐ). The abutment portion 184 may also include a lead-in surface 194 that promotes engagement of locking ring 160 and thrust nut 158. When the locking ring 160 is in the locked condition, the abutment portion 184 of the thrust nut 158 can be nested within the locking ring 160 as shown in FIG. 9.

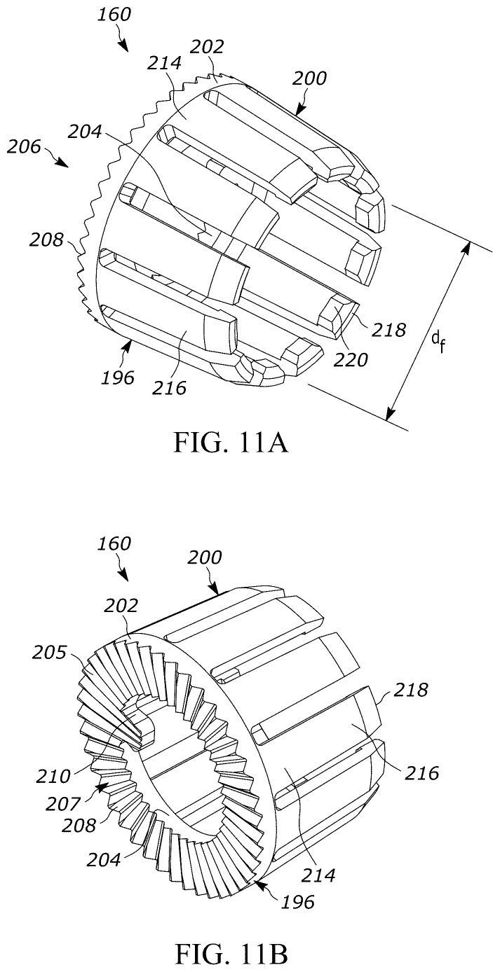

Reference will now follow to FIGS. 11A and 11B, in describing locking ring 160 in accordance with the present disclosure. Locking ring 160 includes a locking ring body 196 and a plurality of flexible and resilient beam fingers 200. The beam fingers 200 can extend axially from the locking ring body 196 in a first direction. The locking ring body 196 can have a generally ring-like portion 202. The beam fingers 200 can be arranged about a circumference of the ring-like portion 202 of the locking ring body 196. It can be appreciated that the number of beam fingers 200 can vary. For example, about 12 to 20 beam fingers can be included. The number of beam fingers 200 on locking ring 160 may correspond to the number of detents 192 on thrust nut 158.

With continued reference to FIGS. 11A and 11B, each beam finger 200 of the locking ring 160 extends or projects in the first direction from the ring-like portion 202 of the locking ring body 196. Ring-like portion 202 includes a central opening 204 that is receptive of shaft 148 of rod-end 124. Ring-like portion 202 includes an outer face 205 including a second sawtooth or serrated surface 207 including a plurality of second teeth elements 208 configured to engage with the first sawtooth surface 140 on face 136 of the head 134 of the shaft 132 to form another part of the first engagement feature 142.

When engaged with the plurality of first teeth elements 141, the plurality of second teeth elements 208 are configured to constrain rotation of locking ring 160 relative to shaft 132. Ring-like portion 202 is further shown to include a key or tab 210 that projects radially inward to central opening 204. Tab 210 is configured to be received in the longitudinal keyway or longitudinal slot 152 on shaft 148 of rod-end 124. The inter-engagement of tab 210 with longitudinal slot 152 constrains rotation of rod-end 124 relative to locking ring 160 about the central longitudinal axis X to form a second engagement feature 212. (FIG. 9)

As further shown in FIGS. 11A and 11B, beam fingers 200 extend from a proximal end 214 arranged at ring-like portion 202 to a distal end 216. Distal end 216 is cantilevered from ring-like portion 202. The beam fingers 200 are substantially parallel to the central longitudinal axis X. The distal ends 216 of the beam fingers 200 define fingertips 218. The fingertips 218 of the beam fingers 200 each include a plurality of beveled surfaces 220. In an aspect of the disclosure, the beveled surfaces 220 are located on the inner sides (i.e., inwardly facing toward the central longitudinal axis) of the fingertips 218. The inner sides of the fingertips 218 define a diameter (D_{f}). Diameter (D_{f}) is substantially similar to diameter (D_{d}) of abutment portion 184 of thrust nut 158.

The beam fingers 200 are resilient and, due to the cantilevered arrangement, the beam fingers 200 can exhibit limited springlike flexibility or elastic deformation in a direction generally transverse to the central longitudinal axis X (i.e., diametrically inward and outward) when subjected to a force, particularly a normal force at the fingertips 218. As further described herein, the fingertips 218 of the beam fingers 200 are configured to mechanically interact with a detent interface 182 of the thrust nut 158. That is, the abutment portion 184 of thrust nut 158 serves as a lead-in surface that spreads beam fingers 200 so as to receive detents 192 to establish a locked condition (i.e., the lock nut assembly 126 is engaged). In the locked condition, the beam fingers 200 and detent interface 182 co-operate with the locking ring 160 to inhibit unintended rotation of the thrust nut 158 relative to the locking ring 160.

As shown in FIG. 9, when the rod-end 124 is threaded to the connecting rod 122 to achieve the precise working length (L) of the self-locking rod-end assembly 120, the thrust nut 158 is engaged with the rod-end 124 and the locking ring 160 is engaged with engagement portion 134 of connecting rod 122. In the locked condition, the connecting rod 122 is rotated in a tightening manner causing tooth interface 137 to impart a rotation force to locking ring 160 through second engagement feature 206. The rotational force causes the thrust nut 158 to move along the shaft 148 of rod-end 124 toward the connecting rod 122. As locking ring 160 is rotated causing the thrust nut 158 to move along shaft 148 of rod-end 124, the beam fingers 200 of the locking ring 160 can engage the detent interface 182 of the thrust nut 158.

As previously described, the cantilevered beam fingers 200 are resiliently flexible, thus as the locking ring 160 is rotated, the fingertips 218 of the beam fingers 200 can alternatively engage the detents 192 (as seen in FIG. 9) and the outer circumferential wall 190 of the detent interface 182 in a “snap-acting” manner. That is, when the fingertips 218 engage the outer circumferential wall 190 of the detent interface 182, the resilient beam fingers 200 are biased outwardly, normal from the central longitudinal axis X. As such, the beam fingers 200 apply a normal force against the detent interface 182 of the thrust nut 158 and produce a tangential friction force against the thrust nut 158. The beveled surfaces 220 of the fingertips 218 aid in the smooth engagement between the beam fingers 200 and detent interface 182. When continued rotation of locking ring 160 causes the beam fingers 200 to engage the detents 192, the bias against the beam fingers 200 is removed and the beam fingers 200 “snap” into engagement with the detents 192. Consequently, the locking ring 160 produces a resistance to rotation that must be overcome during both tightening and loosening of the connecting rod 122. As can be appreciated, rotation of locking ring 160 can be easily accomplished with a tool, and loosening without a tool is substantially prevented.

With continued reference to FIGS. 7-11B, in an aspect of the disclosure, the proximal end 128 of the connecting rod 122 is a mirror image of the distal end 130 of the connecting rod 122, including identical sawtooth or serrated surfaces 140 and plurality of teeth elements 141, and incorporates a mirror-image lock nut assembly 126 and end connector or rod-end 124 described in greater detail above and incorporated herein. When engaged with the mirror-image plurality of first teeth elements 141 at the proximal end 128, the plurality of second teeth elements 208 of the mirror-image locking ring 160 are configured to constrain rotation of locking ring 160 relative to shaft 132. The mirror-image end connector 124 adjustably engages the connecting rod 122 and lock nut assembly 126, as described in greater detail above and incorporated herein.

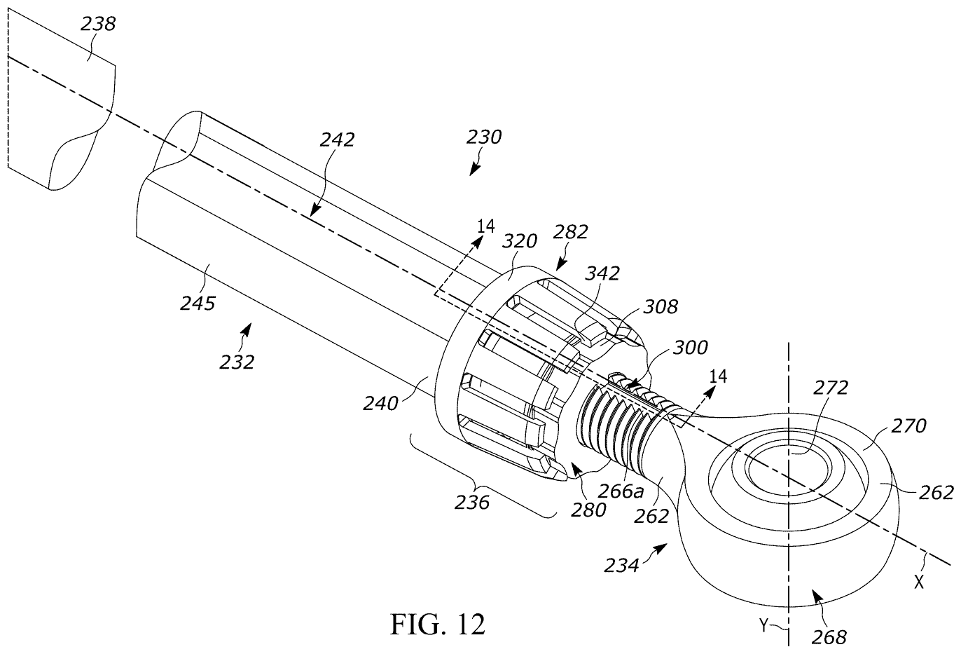

Reference will now follow to FIGS. 12, 13, and 14 in describing an adjustable, self-locking rod-end assembly 230 in accordance with yet another aspect of the present disclosure. In a manner similar to that discussed herein, the adjustable, self-locking rod-end assembly 230 of the present disclosure (e.g., FIGS. 12-14) provides a fastener or connector for use in machines, equipment, mechanical assemblies and like apparatus that enables precision adjustability and includes a self-locking feature that eliminates the need for a secondary locking device like lock wire. The adjustable, self-locking rod-end assembly 230 extends lengthwise along a central longitudinal axis X.

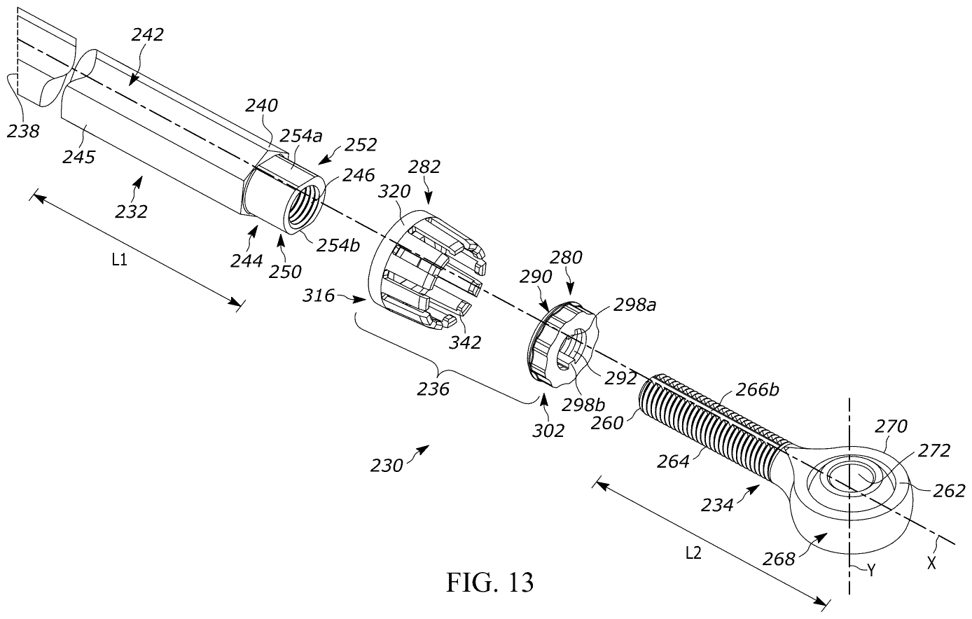

Referring to FIGS. 12 and 13, the adjustable, self-locking rod-end assembly 230 of the present disclosure generally includes a connecting rod 232, an end connector or rod-end 234, and a lock ring assembly 236. The rod-end 234 adjustably engages the connecting rod 232 and lock ring assembly 236. The lock ring assembly 236 engages both the rod-end 234 and the connecting rod 232. The rod-end 234 extends for a working length along the central longitudinal axis X. The threaded engagement between the rod-end 234 and the lock ring assembly 236 enables the rod-end 234 to be adjusted to a precise working length (e.g., as measured along the central longitudinal axis X). In addition to facilitating adjustment of the rod-end 234, the lock ring assembly 236 maintains the precision-adjusted working length of the rod-end 234 even when the rod-end 234 is exposed to harsh operating conditions, such as exposure to extreme vibrations.

The connecting rod 232 can be generally understood as similarly configured as any of a number of well-known internally-or externally-threaded connecting rods, turnbuckle connecting rods or hollow, female-threaded rods. For example, as shown in FIGS. 12 and 13, the connecting rod 232 can extend along the central longitudinal axis X for a length L1 from a first or proximal end 238 to a second or distal end 240. The length L1 of the connecting rod 232 can vary. The connecting rod 232 can include a shaft 242 and an engagement portion or head 244. The outer shape or configuration of the shaft 242 can be generally cylindrical or polygonal or another suitable shape. In accordance with the present disclosure, shaft 242 includes tool-engaging surfaces 245. A portion or the entirety of the connecting rod 232 from the distal end 240 can include the tool-engaging surfaces 245. Further, it is contemplated that the shaft 242 can be polygonal-shaped (e.g., hexagonal) and have a plurality (e.g., 6) of exterior surfaces.

The shaft 242 can be partially or completely hollow and define an inner surface or internal wall 246 at least at the distal end 240. A portion or the entirety of the internal wall 246 can be threaded (e.g., can include female threads). The threads can have a fine or coarse thread pitch. As can be appreciated, the finer the thread pitch, the greater the precision with which the working length of the self-locking rod-end assembly 230 can be adjusted.

The engagement portion or head 244 of the connecting rod 232 can be incorporated at the distal end 240 of the shaft 242. The head 244 can be integrally formed with the shaft 242 or otherwise be affixed or secured to the distal end 240 of the shaft 242. The outer shape or configuration of the head can be similarly formed to the shaft 242. The outer shape of the head 244 can include a first engagement feature 252 that connects with lock ring assembly 236 as will be detailed herein. First engagement feature 252 includes a first flat 254a and a second flat 254b that is directly opposite first flat 254a.

The end connector or rod-end 234 can be generally understood as similarly configured as any of a number of well-known internally-or externally-threaded rod-ends. For example, an end connector or rod-end 234 is also shown in FIGS. 12 and 13. The rod-end 234 can extend along the central longitudinal axis X for a length L2 from a first or proximal end 260 to a second or distal end 262. The length L2 of the end connector can vary. The rod-end 234 can include a shaft 264 and a connecting portion 268. The shaft 264 can be partially or completely threaded (e.g., to include male threads) and includes a first longitudinal slot 266a (FIG. 12) and a second longitudinal slot 266b (FIG. 13). The male threads can have a fine or coarse thread pitch. The male threads can correspond to and mate with the female threads of the connecting rod 232. Rod-end 234 includes a connecting portion 268 that can be integrally formed with the shaft 264 of the rod-end 234. The connecting portion 268 can comprise a rod-end bolt, a ball joint rod-end, a ball joint linkage, a clevis rod-end, a swivel shaft rod-end, or other known connection feature. As shown in FIGS. 12 and 13, the connecting portion 268 is a rod-end bolt 270 having a cylindrical mounting hole 272 extending through the rod-end bolt 270 along a centerline Y and near to the distal end 262 of the connecting portion 268 of rod-end 234.

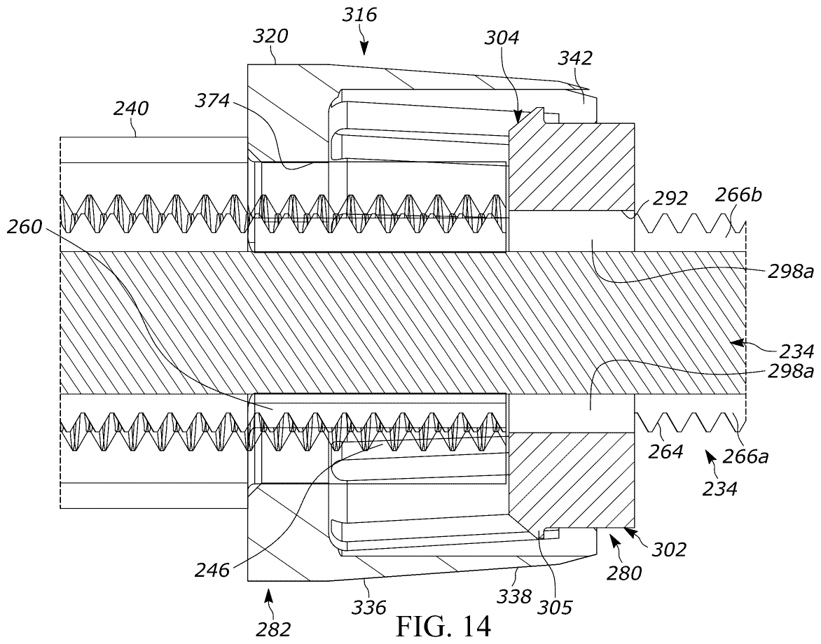

With reference to FIGS. 14, 15A, 15B, 16A, 16B, and with continued reference to FIGS. 12 and 13, lock ring assembly 236 will now be described. The lock ring assembly 236 can have a locked condition and an unlocked condition. The lock ring assembly 236 can include a thrust nut 280 and a locking ring 282. The thrust nut 280 can be disposed between the locking ring 282 and rod-end 234. The locking ring 282 can be rotationally fixed relative to engagement portion 244 of shaft 242 through first engagement feature 252, as further described herein. The thrust nut 280 and locking ring 282 may be brought together along the central longitudinal axis X to place the lock ring assembly 236 in the locked condition. In the locked condition of the lock ring assembly 236, the locking ring 282 can capture the thrust nut 280 and prevent an unintended loosening rotation of the rod-end 234.

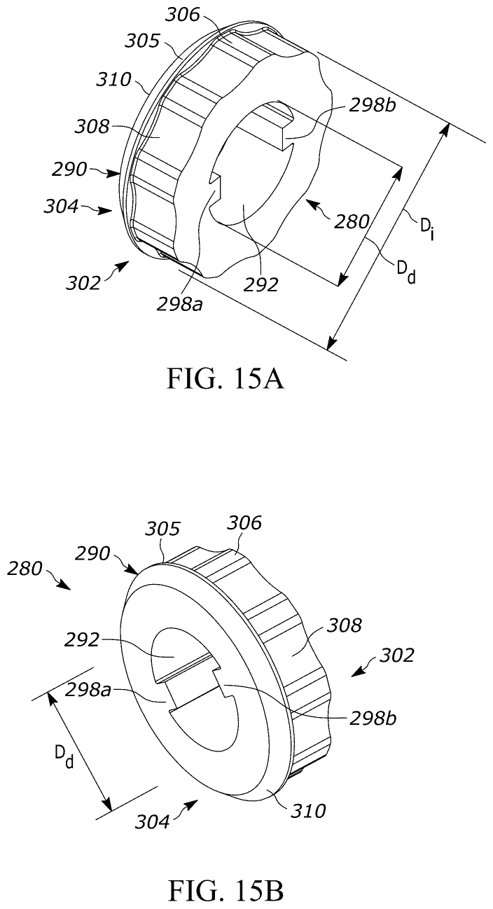

The thrust nut 280 of the lock ring assembly 236 is best seen in FIGS. 15A and 15B. For example, the thrust nut 280 can have a hollow, generally cylindrically-shaped body 290 extending along the central longitudinal axis X. The hollow interior of the thrust nut body 290 can define an inner surface or internal wall 292. Internal wall 292 supports a first key or first tab 298a and a second key or second tab 298b that engage with first longitudinal keyway or slot 266a and second longitudinal keyway or slot 266b respectively to define a second engagement feature 300. Second engagement feature 300 provides a mechanical connection between rod-end 234 and thrust nut 280 of lock ring assembly 236. Thus, but for the inclusion of tabs 298a and 298b, internal wall 292 can be generally circular and corresponds with an outer profile of shaft 242 of rod-end 234.

The outer side of the body 290 can be described as defining a detent interface 302 and a leading end or abutment portion 304 including a raised lip 305. The detent interface 302 can be formed or located on the outer side of the body 290 adjacent to the abutment portion 304. Referring more specifically to the detent interface 302, a portion of the outer side of the body 290 can define a generally cylindrical outer circumferential wall 306 having a diameter (Dᵢ).

Included about the circumference of the generally cylindrical outer circumferential wall 306 are a plurality of equally-spaced, concave-shaped depressions or detents 308. The depths of detents 308 define a diameter (D_{d}). Adjacent detents 308 can be separated from one another by discrete sections of the outer circumferential wall 306. It can be appreciated that the number of detents 308 can vary. For example, about 12 to 20 detents 308 can be included about the outer circumferential wall 306.

Further, it is contemplated that the detent interface 302 can be integrally formed with the outer side of the body 290 of the thrust nut 280. Alternatively, the detent interface 302 can be provided by way of a separate component (e.g., a detent ring) that can be assembled with and/or secured to the outer side of the body 290 of the thrust nut 280. In this respect, the separate detent ring, if so provided, can include the outer circumferential and cylindrical wall 306 comprising the plurality of detents 308. Additionally, the separate detent ring, if so provided, can have an inner side that can be attached to the outer side of the body 290 of the thrust nut 280. The detent ring can be secured to the thrust nut 280, e.g., by a press fit, screw threads, welding, or otherwise.

The abutment portion 304 of the thrust nut 280 can provide a leading end to the thrust nut 280. The abutment portion 304 can have an outer tapered surface 310 forming the lip 305 that promotes engagement with the locking ring 282. When the lock ring assembly 236 is in the locked condition, the abutment portion 304 of the thrust nut 280 can be nested within the locking ring 282 as shown in FIG. 14.

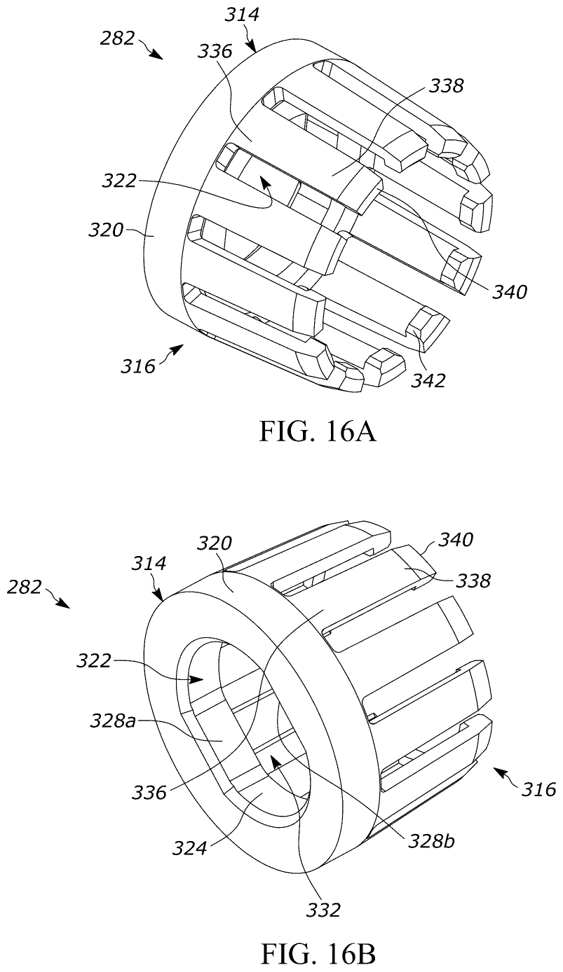

Reference will now follow to FIGS. 16A and 16B, in describing locking ring 282 in accordance with an aspect of the present disclosure. Locking ring 282 includes a locking ring body 314 and a plurality of flexible and resilient beam fingers 316. The beam fingers 316 can extend from the locking ring body 314 in a first direction. The locking ring body 314 can have a generally ring-like portion 320 including a central opening 322. The beam fingers 316 can be arranged about a circumference of the ring-like portion 320 of the locking ring body 314. It can be appreciated that the number of beam fingers 316 can vary. For example, about 12 to 20 beam fingers 316 can be included. The number of beam fingers 316 on locking ring 282 may correspond to the number of detents 308 on thrust nut 280.

Central opening 322 includes a generally annular surface 324 that corresponds to an outer geometry of outer wall 250 of engagement portion 244 of connecting rod 232. The outer wall 250 of the engagement portion 244 can have a smaller diameter than the shaft 242. The generally annular surface 324 includes a first flat surface section 328a and a second flat surface section 328b that is directly opposite the first flat surface section 328a. First flat surface section 328a and second flat surface section 328b form a portion of first engagement feature 252 and may receive first flat 254a and second flat 254b of engagement portion 244 to rotationally fix locking ring 282 relative to connecting rod 232.

With continued reference to FIGS. 16A and 16B, each beam finger 316 of the locking ring 282 extends or projects in the first direction from the ring-like portion 320 of the locking ring body 314. Beam fingers 316 extend from a proximal end 336 arranged at ring-like portion 320 to a distal end 338. Distal end 338 is cantilevered from ring-like portion 320. The beam fingers 316 are substantially parallel to the central longitudinal axis X. The distal ends 338 of the beam fingers 316 define fingertips 340. The fingertips 340 of the beam fingers 316 each include a plurality of beveled surfaces 342 (FIG. 16A). In an aspect of the disclosure, the beveled surfaces 342 are located on the inner sides (i.e., inwardly facing toward the central longitudinal axis) of the fingertips 340. The inner sides of the fingertips 340 define a diameter (D_{f}). Diameter (D_{f}) is substantially similar to diameter D_{d} of abutment portion 304 of thrust nut 280.

The beam fingers 316 are resilient and, due to the cantilevered arrangement, the beam fingers 316 can exhibit limited springlike flexibility or elastic deformation in a direction generally transverse to the central longitudinal axis X (i.e., diametrically inward and outward) when subjected to a force, particularly a normal force at the fingertips 340. As further described herein, the fingertips 340 of the beam fingers 316 are configured to mechanically interact with a detent interface 302 of the thrust nut 280.

As shown in FIG. 14, when the rod-end 234 is threaded to the connecting rod 232 to achieve the precise working length (L) of the self-locking rod-end assembly 230, thrust nut 280 may be slid along shaft 264 such that the abutment portion 304 of thrust nut 280 engages and spreads beam fingers 316 so as to receive detents 308 to establish a locked condition (i.e., the lock ring assembly 236 is engaged). In the locked condition, the beam fingers 316 and detent interface 302 co-operate with the locking ring 282 to inhibit unintended rotation of the thrust nut 280 relative to the locking ring 282. The lip 305 provides a raised surface that prevents fingertips 340 from backing away from or disengaging from the thrust nut 280.

The adjustable, self-locking rod-end assemblies described in accordance with the present disclosure and its various components can be manufactured or formed from any of a variety of materials well-known in the art, such as metals and plastics. Additionally, the adjustable, self-locking rod-end assembly 230 can take the form of a one-ended, adjustable-length fastener or a two-ended, adjustable-length fastener (e.g., a turnbuckle). Still further, at least some of the threaded connections described may be reversed (e.g., internal threads may be external threads and vice versa).

The adjustable, self-locking rod-end assemblies of the present disclosure eliminate the need for a secondary locking device like lock wire. That is, the first and second engagement features form a first or primary locking feature and the beam finger engagement with the detents form a secondary locking feature, thus, there is no need for a secondary locking device. With the adjustable, self-locking rod-end assembly 230 of the present disclosure, therefore, the need to cut and remove any lock wire affixed to the rod-end to conduct maintenance, inspection, repair, replacement, or other service activities on the rod-end, itself, or the machines, equipment, or mechanical assemblies with which the rod-end is associated, and then to reattach the lock wire when the task is complete, is eliminated.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

When the terms “about” or “substantially” are used in this specification in connection with a numerical value, it is intended that the associated numerical value includes a manufacturing or operational tolerance (e.g., ±10%) around the stated numerical value. Moreover, when the terms “generally” or “substantially” are used in connection with geometric shapes, it is intended that precision of the geometric shape is not required but that latitude for the shape is within the scope of the disclosure. Furthermore, regardless of whether numerical values or shapes are modified as “about,” “generally,” or “substantially,” it will be understood that these values and shapes should be construed as including a manufacturing or operational tolerance (e.g., ±10%) around the stated numerical values or shapes.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms “first,” “second,” “third,” etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An adjustable length rod-end assembly comprising:
an end connector extending along a central longitudinal axis and a male-threaded shaft;
a connecting rod extending along the central longitudinal axis, the connecting rod including a female-threaded shaft having a head defining a face and a first engagement feature, wherein the male-threaded shaft of the end connector threadedly engages the female-threaded shaft of the connecting rod to define a precise overall length of the adjustable length rod-end assembly along the central longitudinal axis; and
a lock nut assembly engaging both the end connector and the connecting rod and configured to fix the precise overall length of the adjustable length rod-end assembly along the central longitudinal axis, the lock nut assembly comprising a primary locking feature and a secondary locking feature and including a thrust nut and a locking ring, the thrust nut being fixedly connected to the connecting rod and the locking ring being rotatably fixed relative to the connecting rod;
wherein the thrust nut comprises a body having an internal wall and a detent interface, the thrust nut being rotationally fixed relative to the connecting rod through the first engagement feature and the end connector by a second engagement feature, the first engagement feature and the second engagement feature forming the primary locking feature of the adjustable length rod-end assembly;
wherein the detent interface comprises an outer cylindrical wall in which are included a plurality of concave-shaped detents that are equally spaced about a circumference of the outer cylindrical wall, wherein adjacent detents are separated from one another by discrete sections of the outer cylindrical wall;
wherein the locking ring comprises a locking ring body including a ring-like portion having a central opening and a plurality of resilient beam fingers;
wherein the plurality of resilient beam fingers are arranged and equally spaced about a circumference of the body, wherein each of the plurality of resilient beam fingers extends in a first direction from the body in a cantilevered manner from a proximal end to a distal end, wherein each of the plurality of resilient beam fingers extends generally parallel to the central longitudinal axis; and
wherein the distal end of each of the plurality of resilient beam fingers mechanically interacts with the detent interface to inhibit rotation of the thrust nut to provide the secondary locking feature of the adjustable length rod-end assembly.

2. The adjustable length rod-end assembly according to claim 1, wherein the first engagement feature includes a first flat and a second flat opposite the first flat formed on the head and a first raised feature and a second raised feature opposite the first raised feature formed in the internal wall of the thrust nut, the first flat and the second flat cooperating with the first raised feature and the second raised feature to rotationally fix the connecting rod relative to the thrust nut.

3. The adjustable length rod-end assembly according to claim 2, wherein the second engagement feature includes a plurality of tool-engaging surfaces projecting outwardly from the ring-like portion of the locking ring, the plurality of tool-engaging surfaces forming a hollow interior, and a mechanical fastener threadedly engaged with the male-threaded shaft of the end connector, the mechanical fastener being configured to be received in the hollow interior to rotationally fix the locking ring relative to the end connector.

4. The adjustable length rod-end assembly according to claim 3, wherein the mechanical fastener comprises a hex-nut, and the hollow interior includes a substantially hexagonal geometry that is configured to non-rotationally receive the hex-nut.

5. The adjustable length rod-end assembly according to claim 1, wherein the thrust nut includes a head defining a tool-engaging surface and an abutment portion, the detent interface being arranged between the head and the abutment portion.

6. The adjustable length rod-end assembly according to claim 5, wherein the abutment portion includes a tapered surface and an annular rib defining a first outer diameter of the thrust nut, and a lead-in surface defining a second outer diameter of the thrust nut, the lead-in surface being arranged between the annular rib and the detent interface.

7. The adjustable length rod-end assembly according to claim 6, wherein the distal end of each of the plurality of resilient beam fingers comprises a fingertip having an inner surface, the inner surface defining a beam finger opening having a finger diameter that is substantially equal to the second outer diameter of the thrust nut.

8. An adjustable length rod-end assembly comprising:
an end connector extending along a central longitudinal axis and a male-threaded shaft;
a connecting rod extending along the central longitudinal axis, the connecting rod including a female-threaded shaft having a head defining a face, wherein the male-threaded shaft of the end connector threadedly engages the female-threaded shaft of the connecting rod to define a precise overall length of the adjustable length rod-end assembly along the central longitudinal axis; and
a lock nut assembly engaging both the end connector and the connecting rod and configured to fix the precise overall length of the adjustable length rod-end assembly along the central longitudinal axis, the lock nut assembly comprising a primary locking feature and a secondary locking feature and including a thrust nut and a locking ring, the locking ring being rotatably fixed relative to the end connector;
wherein the thrust nut comprises a body having an internal wall supporting a female-threaded surface and a detent interface, the female-threaded shaft being threadedly connected with the male-threaded shaft of the end connector;
wherein the detent interface comprises an outer cylindrical wall in which are included a plurality of concave-shaped detents that are equally spaced about a circumference of the outer cylindrical wall, wherein adjacent detents are separated from one another by discrete sections of the outer cylindrical wall;
wherein the locking ring comprises a locking ring body including a ring-like portion having a central opening and a plurality of resilient beam fingers, the ring-like portion including a first engagement feature that rotationally fixes the locking ring body relative to the connecting rod and a second engagement feature that rotationally fixes the locking ring body to the end connector, the first engagement feature and the second engagement feature forming the primary locking feature of the adjustable length rod-end assembly;
wherein the plurality of resilient beam fingers are arranged and equally spaced about a circumference of the body, wherein each of the plurality of resilient beam fingers extends in a first direction from the body in a cantilevered manner from a proximal end to a distal end, wherein each of the plurality of resilient beam fingers extends generally parallel to the central longitudinal axis; and
wherein the distal end of each of the plurality of resilient beam fingers mechanically interacts with the detent interface to inhibit rotation of the thrust nut to provide the secondary locking feature of the adjustable length rod-end assembly.

9. The adjustable length rod-end assembly according to claim 8, wherein the locking ring body includes a ring-like surface including an outer surface and a central opening, the plurality of resilient beam fingers extend axially outwardly from the ring-like surface.

10. The adjustable length rod-end assembly according to claim 9, wherein the face of the connecting rod includes a first sawtooth surface including a first plurality of teeth, and the outer surface of the ring-like surface includes a second sawtooth surface including a second plurality of teeth, the first plurality of teeth being configured to engage with the second plurality of teeth to form the first engagement feature.

11. The adjustable length rod-end assembly according to claim 9, wherein the ring-like surface includes a tab projecting radially into the central opening, the tab being configured to engage with a slot that extends along the male-threaded shaft of the end connector to form the second engagement feature.

12. The adjustable length rod-end assembly according to claim 9, wherein the second engagement feature includes a plurality of tool-engaging surfaces projecting outwardly from the ring-like portion of the locking ring, the plurality of tool-engaging surfaces forming a hollow interior, and a mechanical fastener threadedly engaged with the male-threaded shaft of the end connector, the mechanical fastener being configured to be received in the hollow interior to rotationally fix the locking ring relative to the end connector.

13. The adjustable length rod-end assembly according to claim 10, wherein a proximal end of the connecting rod is a mirror-image of the face of the connecting rod including the first plurality of teeth on a third sawtooth surface being configured to engage with a mirror-image ring-like surface of a locking ring body of a mirror-image locking ring to form an engagement feature that rotationally fixes the locking ring body of the mirror-image locking ring relative to the proximal end of the connecting rod.

14. The adjustable length rod-end assembly according to claim 8, wherein the thrust nut includes a head defining a tool-engaging surface, and an abutment portion, the detent interface being arranged between the head and the abutment portion.

15. The adjustable length rod-end assembly according to claim 14, wherein the abutment portion includes a tapered surface, an annular flange defining a first outer diameter of the thrust nut, and a lead-in surface defining a second outer diameter of the thrust nut, the lead-in surface being arranged between the annular flange and the detent interface.

16. The adjustable length rod-end assembly according to claim 15, wherein the distal end of each of the plurality of resilient beam fingers comprises a fingertip having an inner surface, the inner surface defining a beam finger opening having a finger diameter that is substantially equal to the second outer diameter of the thrust nut.

17. An adjustable length rod-end assembly comprising:
an end connector extending along a central longitudinal axis and a male-threaded shaft;
a connecting rod extending along the central longitudinal axis, the connecting rod including a female-threaded shaft having a head, wherein the male-threaded shaft of the end connector threadedly engages the female-threaded shaft of the connecting rod to define a precise overall length of the adjustable length rod-end assembly along the central longitudinal axis; and
a lock nut assembly engaging both the end connector and the connecting rod and configured to fix the precise overall length of the adjustable length rod-end assembly along the central longitudinal axis, the lock nut assembly comprising a primary locking feature and a secondary locking feature and including a thrust nut and a locking ring, the locking ring being rotatably fixed relative to the connecting rod and the thrust nut being rotatably fixed relative to the end connector;
wherein the thrust nut comprises a body having a central opening including an internal wall and a detent interface; wherein the detent interface comprises an outer cylindrical wall in which are included a plurality of concave-shaped detents that are equally spaced about a circumference of the outer cylindrical wall, wherein adjacent detents are separated from one another by discrete sections of the outer cylindrical wall;
wherein the locking ring comprises a locking ring body including a ring-like portion having a central opening and a plurality of resilient beam fingers, the ring-like portion including a first engagement feature that rotationally fixes the locking ring body relative to the connecting rod, the body of the thrust nut including a second engagement feature that rotatably fixes the thrust nut relative to the end connector, the first engagement feature and the second engagement feature forming the primary locking feature of the adjustable length rod-end assembly;
wherein the plurality of resilient beam fingers are arranged and equally spaced about a circumference of the body, wherein each of the plurality of resilient beam fingers extends in a first direction from the body in a cantilevered manner from a proximal end to a distal end, wherein each of the plurality of resilient beam fingers extends generally parallel to the central longitudinal axis;
wherein the distal end of each of the plurality of resilient beam fingers mechanically interacts with the detent interface to inhibit rotation of the thrust nut and provide the secondary locking feature of the adjustable length rod-end assembly; and
wherein the central opening of the thrust nut includes a first tab projecting radially outwardly from the internal wall and a second tab projecting radially outwardly from the internal wall, the first tab and the second tab being configured to engage with a first longitudinal slot and a second longitudinal slot formed on the male-threaded shaft to form the second engagement feature.

18. The adjustable length rod-end assembly according to claim 17, wherein the locking ring body includes a ring-like surface including a central opening having a first flat surface section and a second flat surface section and the head of the connecting rod includes a first flat and a second flat arranged opposite the first flat, the first flat and the second flat being configured to engage corresponding ones of the first flat surface section and the second flat surface section to form the first engagement feature.

19. The adjustable length rod-end assembly according to claim 17, wherein the male-threaded shaft of the end connector includes a proximal end and a distal end, the thrust nut being slidable on the male-threaded shaft between the proximal end and the distal end.

20. The adjustable length rod-end assembly according to claim 19, wherein the thrust nut includes an abutment feature including a tapered surface forming a lip, the lip being selectively engaged by the plurality of resilient beam fingers to prevent the thrust nut from disengaging from the locking ring.
